(19) United States
(12) Patent Application Publication
(10) Pub. No.: US 2026/0184556 A1
(43) Pub. Date: Jul. 2, 2026

(54) Anti-Drip Device for a Beverage Dispensing Assembly

(71) Applicant: Heineken Supply Chain B.V., Amsterdam (NL)

(72) Inventors: Arie Maarten Paauwe, Amsterdam (NL); Petronella Joanna Zeegers, Alphen aan den Rijn (NL)

(21) Appl. No.: 19/131,270

(22) PCT Filed: Nov. 21, 2023
(86) PCT No.: PCT/NL2023/050608

§ 371 Date: May 20, 2025

(30) Foreign Application Priority Data
Nov. 21, 2022 (EP) 22208572.2

(51) Int. Cl. B67D 1/12; B67D 1/16

(52) U.S. Cl. CPC B67D 1/1256; B67D 1/16; B67D 2210/00049

(57) ABSTRACT

Anti-drip device for a beverage dispensing assembly. Dispensing line part for use in a beverage dispensing assembly, the dispensing line part comprising:
a beverage conduit with a passage for transporting a nonalcoholic beverage through said conduit;
an upstream connector arranged for connecting the beverage conduit to a beverage container holding a non-alcoholic beverage, wherein the upstream connector has a beverage contact surface which in use contacts beverage; and
a downstream connector, arranged for connecting the beverage conduit to a beverage dispensing system; wherein the beverage conduit extends between the upstream connector and the downstream connector, and wherein the dispensing line part further comprises an exterior liquid trap, arranged for preventing a flow of liquid flowing over an exterior surface of the beverage conduit from reaching the beverage contact surface of the upstream connector.

### TECHNICAL FIELD

The aspects and embodiment thereof relate to the field of beverage dispensing assemblies, in particular hygienic improvements to beverage dispensing assemblies.

### BACKGROUND

There is a wide variety of beverage dispensing assemblies available for dispensing all sorts of beverages. A common beverage dispensing assembly that is often used for dispensing beverages in food and beverage service establishments and hospitality industry, such as bars and restaurants, comprises a beverage container containing a beverage and a beverage dispensing line extending between the beverage container and a beverage dispenser, such as a faucet with tap handle, for dispensing the beverage at a dispensing outlet of the dispenser, with a coupler device arranged for coupling the beverage dispensing line to the beverage container, wherein a piston in the coupler device is movably arranged for causing a beverage container sealing member to open to provide a fluid connection between the beverage container and the beverage dispensing line.

As such with the known beverage dispensing assembly a beverage can be dispensed by first actuating the piston in the coupler device to cause the beverage container sealing member to open, so called broaching of the beverage container. After broaching, beverage contained in the beverage container may freely flow past the opened sealing member through the coupler device into the beverage dispensing line up to a dispensing valve, which is usually provided in the dispenser.

The dispenser may be operated as desired to open and close the dispensing valve, wherein when the dispensing valve is opened an amount of beverage can flow from the beverage container through the coupler device and dispensing line to a dispensing opening of the dispenser for dispensing the beverage in a suitable receptacle such as a drinking glass or cup.

During its lifetime in use, the dispensing assembly is exposed to microorganisms present in the environment of the dispensing assembly. These microorganisms pose a risk of infiltrating particularly the dispensing line and coupler, for example during an exchange of beverage containers. When removing the coupler from a first container and coupling of the coupler device to a new beverage container holding a fresh amount of beverage, such microorganisms may migrate from the dispensing line into the beverage kept in the beverage container, which forms a suitable and sufficient source of nutrients for the microorganisms to expand rapidly by multiplication. As a result, a shelf life of such beverage contained in the beverage container, i.e. period in which the beverage in the container may normally be suitably consumed, may decrease and/or the beverage may prematurely become spoiled otherwise.

Furthermore, if the beverage has a low alcohol by volume percentage, or is completely alcohol free, and/or has a relatively high sugar content, such as some alcohol free beers, the beverage is particularly susceptive for contamination by fermenting microorganisms such as wild yeast, which may lead to unwanted increase of alcohol contents in the beverage due to fermentation.

In WO2022093018, solutions are proposed for preventing microorganism contamination of the beverage contained in the beverage container of such beverage dispensing assembly. Specifically, WO2022093018 proposes to prevent backflow of liquid and microorganisms from the beverage dispensing line into the beverage container of such beverage dispensing assembly.

### SUMMARY

Although the solutions proposed in WO2022093018 are effective in preventing microorganism contamination of the beverage contained in the beverage container through the dispensing line, it has been observed that also microorganism contamination may occur from outside the dispensing line in particular when the coupler device of the beverage dispenser assembly is not properly used and/or cleaned.

It has been observed that when a dispensing line part of the coupler device is disconnected from the beverage container, beverage may leak out of the dispensing line part, in the form of liquid and/or foam. This leaked beverage may flow down the exterior of the dispensing line part, in particular over a beverage conduit, towards an upstream connector of the dispensing line part, for example by virtue of gravity. If the leaked beverage reaches a beverage contact surface of the upstream connector and the upstream is reconnected to a beverage container—which may be against manufacturer instructions—beverage dispensed by the beverage dispensing assembly following this reconnection may become contaminated. In particular, beverage inside a beverage container may become contaminated. Contamination, for example with yeast cells, of a non-alcohol beverage inside the beverage container is preferably prevented.

In order to prevent, or at least reduce a chance of, contamination of beverage in a beverage container by leaked beverage flowing down the exterior of the dispensing line part, the present disclosure provides in a first aspect a dispensing line part for use in a beverage dispensing assembly. The dispensing line part comprises a beverage conduit with a passage for transporting a non-alcoholic beverage through said conduit, an upstream connector arranged for connecting the beverage conduit to a beverage container holding a non-alcoholic beverage, wherein the upstream connector has a beverage contact surface which in use contacts beverage, and a downstream connector, arranged for connecting the beverage conduit to a beverage dispensing system.

The beverage conduit extends between the upstream connector and the downstream connector, and the dispensing line part further comprises an exterior liquid trap, arranged for preventing a flow of liquid flowing over an exterior surface of the beverage conduit from reaching the beverage contact surface of the upstream connector.

By virtue of the exterior liquid trap, a chance of contamination of the beverage in the beverage container by leaked beverage flowing down the exterior of the dispensing line part can be reduced, preferably to a zero chance, by preventing a flow of liquid flowing over an exterior surface of the beverage conduit from reaching the beverage contact surface of the upstream connector.

The exterior liquid trap is preferably arranged to catch, redirect, absorb, or otherwise interact with fluid flowing over the beverage conduit before said fluid can reach the upstream connector. It will be understood that in general, the flow of liquid over the exterior surface of the beverage conduit may consist of a single droplet of fluid, or may comprise multiple droplets and/or a continuous stream of fluid. The fluid may in general be in liquid state and/or in a foamed state, and may comprise beverage such as non-alcoholic beer.

The exterior liquid trap may be connectable to the exterior surface of the beverage conduit, for example by a clamped connection or a form-fitted connection. In a clamped connection, at least part of the exterior liquid trap may be elastically deformed to provide a clamping force to the beverage conduit. In a form-fitted connection, the exterior liquid trap may for example be at least partially wrapped around part of the beverage conduit. Typically, for a form-fitted connection, a plastic and/or elastic deformation of at least one of the beverage conduit and the exterior liquid trap is required to disconnect the exterior liquid trap from the beverage conduit.

The exterior liquid trap may hence be a component manufactured separate from the beverage conduit. By connecting the exterior liquid trap to the beverage conduit, a conventional production process may be used for manufacturing the beverage conduit, while another production process may be used for manufacturing the exterior liquid trap. For example, the beverage conduit may be formed in an extrusion process to obtain a beverage conduit with a substantially constant cross-sectional shape. Additionally or alternatively, the beverage conduit may be manufactured such that is has a substantially smooth exterior surface.

The beverage conduit may in any embodiment of the dispensing line part be embodied as a flexible tube, for example a flexible plastic tube. Generally, the beverage conduit may have a length of 5 cm or longer, 10 cm or longer, 20 cm or longer, 30 cm or longer, but may be below 100 cm or even below 50 cm. Preferably, the beverage conduit has a length of approximately 10 cm.

Next to or as an alternative to clamping the exterior liquid trap to the exterior surface of the beverage conduit, the exterior liquid trap may be glued to the exterior surface of the beverage conduit. Gluing may provide for a convenient yet durable connection method for connecting the exterior liquid trap to the exterior surface of the beverage conduit.

Next to or as an alternative to clamping the exterior liquid trap to the exterior surface of the beverage conduit, the exterior liquid trap may adhere to the exterior surface of the beverage conduit. To adhere is generally defined as to hold fast or stick by as if by gluing, suction, grasping, or fusing.

A flow of liquid flowing over the beverage conduit and reaching the exterior liquid trap may be guided away from the beverage contact surface of the upstream connector. Generally, a flow of liquid may stick to the exterior liquid trap due to adhesion. The term adhesion may be used to describe a liquids tendency to be attracted to other materials, such as the material of an exterior surface of the dispensing line part, in particular an exterior surface of the beverage conduit and the exterior liquid trap. Due to adhesion, gravity may not be sufficient to pull the liquid away from the beverage conduit.

As a particular option, the exterior liquid trap is or comprises a length of tape at least partially wrapped around the exterior surface of the beverage conduit. Preferably, but not necessarily, part of the length of tape extends away from the exterior surface of the beverage conduit. Tape may be generally defined as a thin substrate with a glue or adhesive applied to at least part of one of the faces of the substrate. In particular, tape may be adhesive tape. A thin substrate may for example have a thickness below 1 mm, in particular below 0.5 mm. The glue or adhesive may be suited to glue tape to itself.

When the exterior liquid trap comprises a length of tape, the length of tape may be at least partially folded over the exterior surface of the beverage conduit. Preferably, two outer ends of the length of tape are connected with or near each other. The two outer ends of the length of tape may be connected at a distance from the exterior surface of the beverage conduit. The length of tape may thus be folded back over itself. This may provide for an additional form-fitted connection of the tape to the beverage conduit, next to the glued connection.

Alternatively or additionally, the exterior liquid trap may be or comprise a length of cord, rope or string which is wrapped around the exterior surface of the beverage conduit. Alternatively or additionally, the exterior liquid trap may be formed on the exterior surface of the beverage conduit by melting, printing, or otherwise adding material to the exterior surface. Any of these options may be readily applied to any dispensing line part disclosed herein, in any combination.

Next to or as alternative to redirecting the flow of liquid which flows over the exterior surface of the beverage conduit, at least part of the flow of liquid may be absorbed by the exterior liquid trap, in particular when the exterior liquid trap comprises a liquid-absorbing material. By virtue of a liquid-absorbing material, the exterior liquid trap may guide the liquid into the exterior liquid trap itself, thereby preventing or reducing a flow of liquid over an exterior surface of the beverage conduit from the downstream connector to the upstream connector.

As an option, the exterior liquid trap may comprise a hydrophobic exterior surface. Such a hydrophobic exterior surface may decrease adhesion between liquid and said exterior surface. As such, for example, the liquid may be pulled away from the exterior surface by virtue of gravity. When the liquid is pulled away from the exterior surface of the conduit, one or more drops of liquid may be formed which may fall from the exterior liquid trap. These fallen drops may fall at a distance from the upstream connector, and as such contamination of the upstream connector may be prevented.

Any hydrophobic exterior surface may be formed by virtue of the exterior liquid trap being formed at least in part from hydrophobic material and/or by coating at least part of the exterior surface of the exterior liquid trap with a hydrophobic material.

Examples of materials which may be used to form at least part of the hydrophobic exterior surface are cellulose acetate, polypropylene, and silicone. It will however be appreciated that any other hydrophobic material may be used.

Additionally or alternatively, any exterior liquid trap may be at least partially essentially nonporous for liquid, in particular for alcohol-free beer. This may prevent liquid from becoming trapped in the exterior liquid trap, which in turn may cause the exterior liquid trap to become saturated with liquid. A saturated exterior liquid trap may cease to function effectively as a liquid trap.

Additionally or alternatively, any exterior liquid trap may be at least partially essentially impermeable for liquid, in particular for alcohol-free beer. This may prevent liquid from becoming trapped in the exterior liquid trap, which in turn may cause the exterior liquid trap to become saturated with liquid. A saturated exterior liquid trap may cease to function effectively as a liquid trap.

It will be appreciated that a single exterior liquid trap may have a hydrophobic exterior surface, and can also be essentially non-porous for liquid and/or essentially impermeable for liquid.

As a further option, the exterior liquid trap may be arranged to catch at least part of the flow of liquid flowing over the exterior surface of the beverage conduit from the downstream connector to the upstream connector. Catch at least part of the flow of liquid implies that the at least part of the flow of liquid flowing over the exterior surface of the beverage conduit from the downstream connector to the upstream connector is stopped by the exterior liquid trap. For example, any exterior liquid trap disclosed herein may comprise a liquid reservoir in which the caught liquid can be held. The liquid reservoir may be arranged for holding a volume of trapped liquid.

An opening of said liquid reservoir may generally face the downstream connector and/or may generally face away from the upstream connector. Additionally or alternatively, the opening of the liquid reservoir may be oriented in a downstream direction for beverage flowing through the beverage conduit. With any of these orientations of the opening of the liquid reservoir, a flow of liquid flowing over the outside surface of the beverage conduit originating from the direction of the downstream connector may be caught in the liquid reservoir.

As an option for any exterior liquid trap disclosed herein, the exterior liquid trap may have one or more visible markings on an outer surface of the exterior liquid trap. Such markings may for example represent one or more letters, words, images, colours, or any other visually distinguishable marking such as arrows, symbols, or any other shape. The marking may for example be used to identify the exterior liquid trap to user, and/or for example to allow the user to properly orientate the exterior liquid trap, in particular relative to one or more of the downstream connector, upstream connector, and gravity.

For any dispensing line part according to the first aspect, at least part of the exterior liquid trap may be oriented away from the exterior surface of the beverage conduit. Additionally or alternatively, for any dispensing line part according to the first aspect, the beverage conduit may have a substantially constant cross-sectional shape and/or a substantially smooth exterior surface.

A second aspect of the present disclosure provides a beverage dispensing assembly comprising a beverage container with a container body defining a beverage chamber for containing a beverage, the container body comprising a beverage outlet, a beverage dispenser, such as a faucet with a tap handle, for dispensing the beverage at a dispensing outlet of the dispenser, and a dispensing line part, wherein the dispensing line part is connected between the beverage container and the beverage dispenser.

The beverage dispenser assembly comprises any dispensing line part disclosed herein. The upstream connector of the dispensing line part may be connected to the beverage container, for example to the beverage outlet of the beverage container, or to another dispensing line part. The downstream connector of the dispensing line part may be connected to the beverage dispenser, or to another dispensing line part. In use, beverage flows through the dispensing line part from the upstream connector to the downstream connector.

The upstream connector of the dispensing line part is typically positioned lower than the downstream connector of the dispensing line part, for example when the beverage container is positioned generally below the beverage dispenser. When the upstream connector is positioned lower than the downstream connector, gravity may cause liquid positioned at or near the downstream connector to flow downwards towards the upstream connector via the exterior surface of the beverage conduit.

When the upstream connector of the dispensing line part is in use positioned lower than the downstream connector of the dispensing line part, the exterior liquid trap may be positioned at any height between the upstream connector and the downstream connector. As such, the exterior liquid trap may be placed in a flow path for liquid flowing over the exterior of the beverage conduit from the downstream connector downwards towards the upstream connector.

The beverage chamber of the beverage container may contain a volume of non-alcoholic beverage, in particular alcohol-free beer. In use, the beverage container may be placed in a cooled environment, such as a fridge, or the beverage container may be placed in a non-cooled environment at ambient temperature. The beverage container may for example be a conventional metal keg, or a bag-in-container. The definition of a non-alcoholic beverage may depend on local or regional legislation. In the present disclosure, non-alcoholic beverage refers to a beverage with an alcohol-by-volume content below 1%, below 0.5%, below 0.1%, even below 0.05% or even 0.00%.

Any beverage chamber disclosed herein may contain a carbonated beverage. When the beverage chamber contains a carbonated beverage, the beverage may form into a foam, in particular when exposed to ambient pressure. When the beverage forms from a liquid into a foam, the volume of the beverage expands, leading to beverage leaking out of the downstream connector. This leaked beverage may then flow down the beverage conduit towards the upstream connector, which is preferably prevented using the exterior liquid trap. Whenever in the present disclosure a carbonated beverage is referred to, it will be understood that also other beverages comprising a dissolved gas are envisioned, for example comprising nitrogen. A carbonated beverage is commonly pressurized by the gas contained in the beverage and/or by outside pressure, in order to contain a desired gas content of the beverage.

In use, the beverage conduit of the dispensing line part may be entirely oriented in a downward and/or horizontal direction. As such, the lowest point of the beverage conduit is not lower than the upstream connector. If part of the beverage conduit is positioned lower than the upstream connector, due to gravity, a flow of liquid might not be able to flow past this lower point towards the upstream connector. The part of the beverage conduit below the upstream connector may as such form an exterior liquid trap.

### BRIEF DESCRIPTION OF THE FIGURES

In the figures:

FIG. 1A schematically depicts an embodiment of a dispensing line part in a beverage dispensing assembly;

FIG. 1B shows a schematic cross-section of the beverage conduit of FIG. 1A;

FIG. 2A schematically depicts another embodiment of a dispensing line part in a beverage dispensing assembly;

FIGS. 2B and 2C show schematic cross-sections of the beverage conduit of FIG. 2A;

FIG. 3A shows yet another embodiment of a dispensing line part;

FIG. 3B shows a schematic cross-section of the beverage conduit of FIG. 3A;

FIGS. 4A and 4B show two views of a dispensing line part; and

FIG. 5A shows a section view of a coupler device; and

FIGS. 5B and 5C show a detailed view of FIG. 5A.

### DETAILED DESCRIPTION OF THE FIGURES

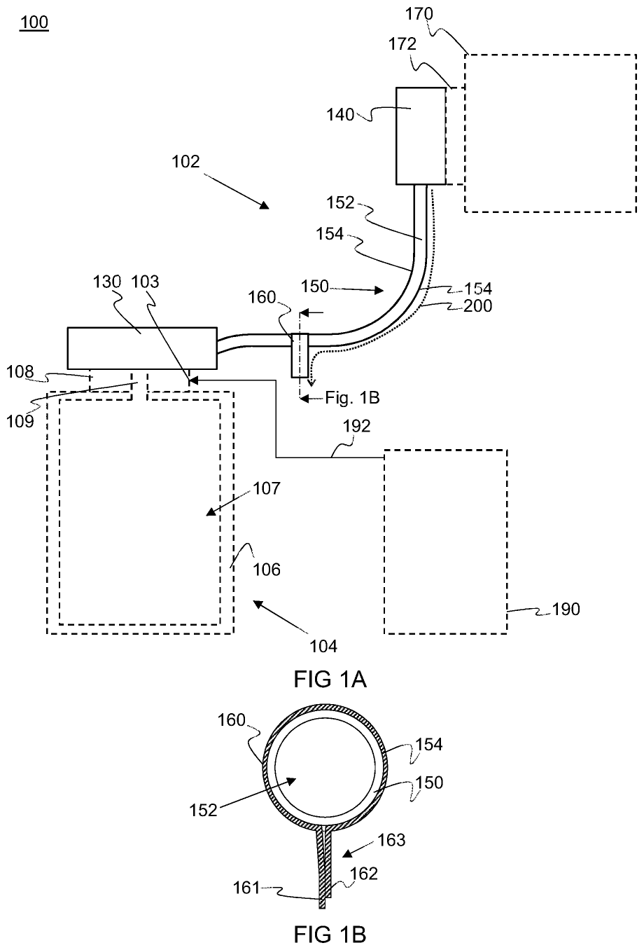

FIG. 1A schematically depicts an embodiment of a dispensing line part 102 in a beverage dispensing assembly 100. The dispensing line part 102 comprises an upstream connector 120, a downstream connector 140, and a beverage conduit 150 with a passage 152 and extending between the upstream connector 130 and the downstream connector 140. In use, the beverage conduit 150 with the passage 152 places the upstream connector 130 and the downstream connector 140 in fluid communication with each other. Preferably, beverage flows through the beverage conduit 150 from the upstream connector 130 to the downstream connector 140.

It should be noted that FIG. 1A is merely a schematic figure, and the different elements depicted, such as the beverage container, beverage dispenser, and dispensing line part, are not necessarily to scale.

The beverage dispensing assembly 100 comprises a beverage container 104 with a container body 106 defining a beverage chamber 107 for containing a beverage. The beverage container 104 has a beverage container interface 108 to which the upstream connector 120 of the dispensing line part 102 can be connected. Beverage can flow from the beverage chamber 107 through a beverage outlet 109 to the upstream connector 130. Although the upstream connector 120 is in FIG. 1A shown directly connected to the beverage container interface 108, it will be understood that it is also envisioned to use a coupler device for coupling the upstream connector 120 to the container interface 108.

In general, applicable for any embodiment of a beverage container 104 and applicable for any embodiment of the beverage dispensing assembly, a coupler may be connected to the container interface 108 in a twisting, rotational, translational, and/or sliding motion. For example, the container interface 108 may form a bayonet connection with the coupler, such as in a Sankey interface or the container interface 108 may form a sliding connection, such as in a Micro Matic connection.

As an option for any beverage dispensing assembly disclosed herein, when the beverage dispensing assembly comprises a coupler, the coupler may be reusable, whereas the dispensing line part may be disposable. In particular, the dispensing line part contacts beverage in use and would therefore require cleaning if reused to prevent contamination of beverage after reusing the dispensing line part—for example after connecting the dispensing line part to a further beverage container after being disconnected from a first beverage container. Contamination may even occur when the dispensing line part is temporarily disconnected from a beverage container, and subsequently reconnected to said beverage container —which may be contrary to recommended practice. The exterior liquid trap as disclosed herein may reduce change of contamination. The coupler may be used to broach a beverage container using the upstream connector of the dispensing line part.

For constituting the flow of beverage, a pressurised gas may be used. In the example of FIG. 1A, a pressurised gas source 190 is comprised by the beverage dispensing assembly 100, and is connected to supply a flow of pressurised gas 192 to a gas inlet 103 of the beverage container 104. The gas inlet 103 is thus in the example of FIG. 1 comprised by the beverage container 104, in particular by the beverage container interface 108, but may in other examples be comprised by the upstream connector 130.

The pressurised gas may for example be supplied into the beverage chamber 107 for forcing the beverage through a conventional tube inside the beverage chamber and out of the beverage chamber through the beverage outlet 109. Alternatively, for example when the beverage container 104 is a bag-in-container type of container, pressurised gas may be pumped into a space between an outer container of the beverage container and a collapsible inner container of the beverage container positioned inside the outer container.

The beverage dispensing assembly 100 schematically depicted in FIG. 1A further comprises a beverage dispenser 170. The beverage dispenser 170 comprises a beverage dispenser interface 172 to which the downstream connector 140 of the dispensing line part 102 can be connected.

Schematically depicted in FIG. 1A as a dotted line 200 is a flow of liquid 200 flowing over an exterior surface 154 of the beverage conduit 152. In particular, the flow of liquid 200 flows towards the upstream connector 130, for example by virtue of gravity.

The dispensing line part 102 comprises an exterior liquid trap 160, arranged for preventing the flow of liquid 200 flowing over the exterior surface 154 of the beverage conduit 150 from reaching the upstream connector 130. FIG. 1B shows a schematic cross-section of the beverage conduit 150, with a particular embodiment of an exterior liquid trap 160 which may be readily comprised by any other dispensing line part and beverage dispensing assembly of the present disclosure.

In the embodiment of FIG. 1B, the exterior liquid trap 160 is formed by a length of tape (shown hatched), which is wrapped around the beverage conduit 150. The length of tape may be glued to the exterior surface 154 of the beverage conduit 150. For example, the tape may be adhesive tape, preferably with one adhesive side.

The length of tape 160 has two free ends 161, 162, as depicted in FIG. 1B. The two free ends 161 162 are positioned at a distance from the exterior surface 154 of the beverage conduit 150. Embodiments are also envisioned wherein only one of the ends is a free end positioned at a distance from the exterior surface 154, and another of the ends may for example be glued onto the exterior surface 154.

In the embodiment of FIG. 1B, between the two free ends 161, 162, an extending part 603 is formed by the length of tape 600 extending away from the exterior surface 154 of the beverage conduit 150. When the flow of liquid 200 flowing over the exterior surface 154 reaches the length of tape 600, the flow of liquid 200 flows over the length of tape, in particular over the extending part 603, towards at least one of the ends 161, 162. As such, it may be prevented that the flow of liquid 200 reaches the upstream connector 130. The flow of liquid 200 may thus adhere to the length of tape, similarly to how the flow of liquid 200 previously adhered to the exterior surface 154 of the beverage conduit 150.

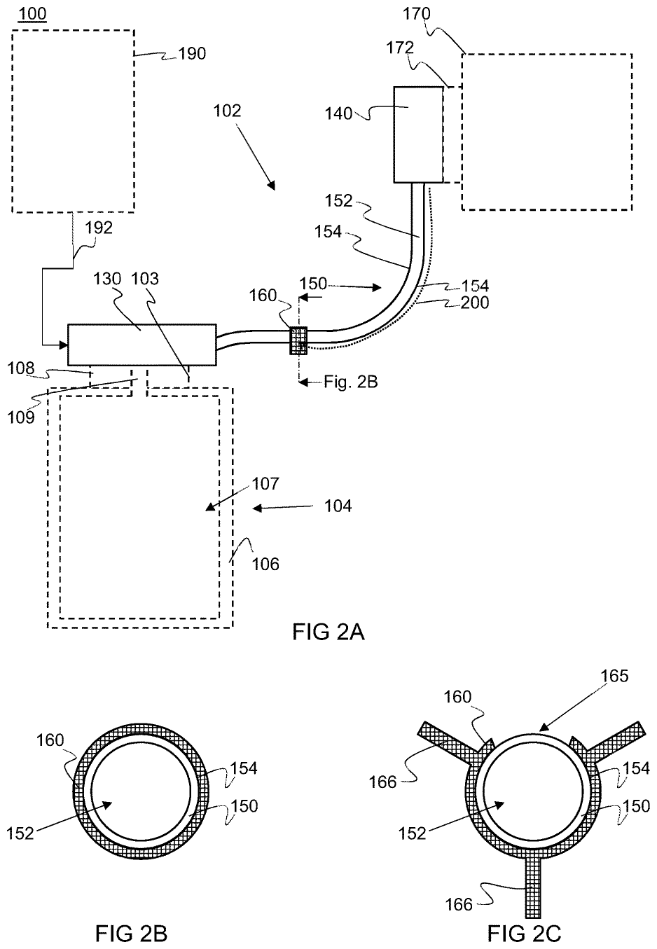

FIG. 2A schematically shows another embodiment of a dispensing line part 102 shown in another embodiment of the beverage dispensing assembly 100. In this embodiment, the pressurised gas source 190 is connected to the upstream connector 130 of the dispensing line part 102. As such, the flow of pressurised gas 192 can be provided to the beverage container 104 via the upstream connector 130. In the present disclosure, pressurised gas can be directly fed into the beverage chamber 107, or be used to collapse a collapsible inner container or collapsible bag of the beverage container 104, for example when the beverage container 104 is a bag-in-container or bag-in-bottle type of container.

FIG. 2B and FIG. 2C show optional cross-sections of the beverage conduit 150 shown in FIG. 2A provided with an embodiment of the external liquid trap 160 (shown hatched). In the embodiment of FIG. 2B, the external liquid trap 160 fully surrounds the beverage conduit 150, in particular the external surface 154 of the beverage conduit 150. The external liquid trap 160 may comprise or consist of liquid-absorbing material, such that the external flow of liquid 200 when contacting the external liquid trap 160 can be at least partially absorbed. It will be appreciated that any embodiment of the external liquid trap 160 disclosed herein may comprise liquid-absorbing material. In general, regardless of the material(s) forming the external liquid trap 160, the external liquid trap 160 may be embodied as an O-ring.

In the alternative shown in FIG. 2C, the external liquid trap 160 only partially surrounds the beverage conduit 150. As such, for example, the external liquid trap 160 may be conveniently clamped or snapped onto the beverage conduit 150. The external liquid trap 160 may for example have a discontinuity 165 which allows the external liquid trap 160 to elastically deform when being clamped or snapped onto the beverage conduit 150.

As an option depicted in FIG. 2C, the external liquid trap 160 is shown comprising a plurality of protrusions 166 oriented away from the exterior surface 154 of the beverage conduit 150. A protrusion 166 may be used to guide the flow of liquid 200, in particular in a direction away from the exterior surface 154, when the flow of liquid 200 adheres to a protrusion 166. When a plurality of protrusions 166 are used, a rotational orientation of the external liquid trap 160 relative to gravity may become less critical.

It will be appreciated that any external liquid trap disclosed herein may comprise any number of protrusions 166, for example two, three, four, or even more. The protrusions may be positioned at an angular spacing relative to each other, for example at a constant angular spacing. For example, as depicted in FIG. 2C, when the external liquid trap 160 comprises three protrusions 166, the protrusions may be spaced 120 degrees apart. It will further be appreciated that the protrusions 166 and the discontinuity 165 are regarded as separate options which may be applied separately or together in any embodiment of the external liquid trap 160.

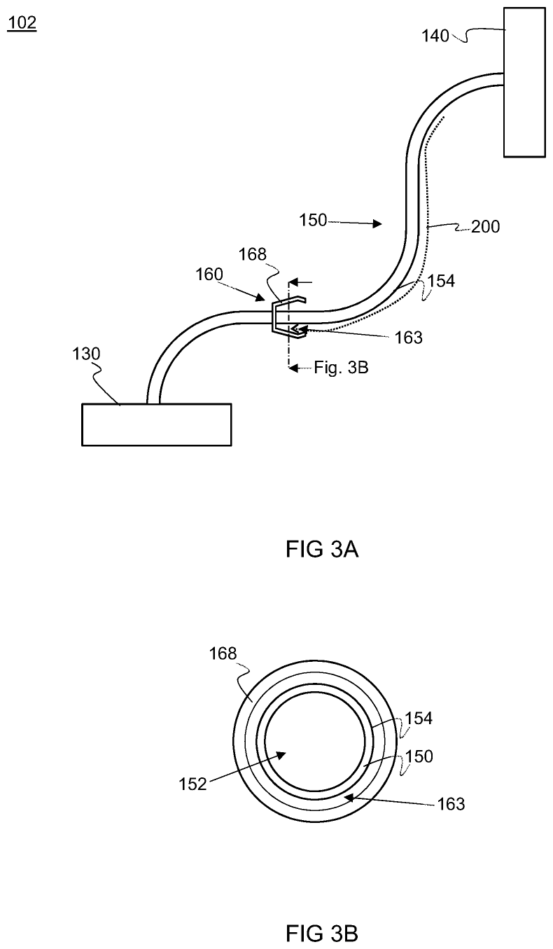

FIG. 3A schematically shows another embodiment of a dispensing line part 102, comprising the upstream connector 130, downstream connector 140, and beverage conduit 150 in-between the upstream connector 130 and the downstream connector 140.

In the embodiment of FIG. 3A, the dispensing line part 102 is depicted comprising another embodiment of an exterior liquid trap 160. As with all exterior liquid traps disclosed herein, the exterior liquid trap depicted in FIG. 3A may be readily comprised by any dispensing line part disclosed herein. FIG. 3B shows a cross-sectional view of the beverage conduit 150 and the exterior liquid trap 160 connected to the beverage conduit 150.

The exterior liquid trap 160 depicted in FIGS. 3A and 3B is particularly arranged to trap at least part of the flow of liquid 200 flowing over the exterior surface 154 of the beverage conduit 150 from the downstream connector 140 to the upstream connector 130. To this end, the exterior liquid trap 160 comprises a liquid reservoir 168 for holding a volume of trapped liquid. The liquid reservoir 168 has an opening 163 through which liquid can be received.

The opening 163 of the liquid reservoir 168 is in FIG. 3A show oriented in a downstream direction for beverage flowing through the beverage conduit. In other words, the opening 163 generally faces towards the downstream connector 140 and/or faces away from the upstream connector 130.

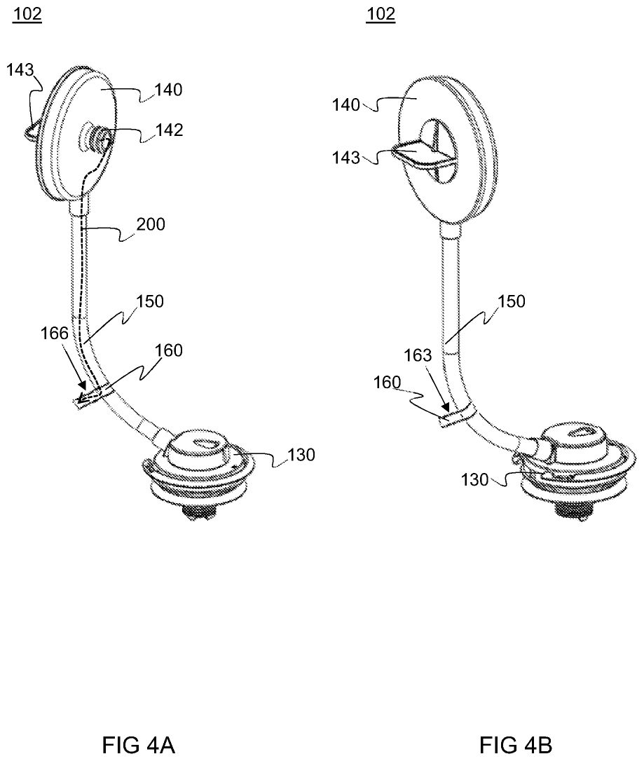

FIGS. 4A and 4B show two isometric views of a particular embodiment of a dispensing line part 102. In particular, in the two views, two sides of the downstream connector 140 is visible. On a first side visible in FIG. 4A, the downstream connector 140 comprises a beverage outlet 142 through which in use beverage can flow to a beverage dispenser. On a second side, best visible in FIG. 4B, the downstream connector 140 may comprise a handle 143 which a user can hold to manipulate a position of the downstream connector 140. The handle 143 can for example be pinched between fingers of the user. FIG. 4A schematically shows how a flow of liquid 200, in particular a flow of beverage, can flow out of the beverage outlet 142 of the downstream connector, and over the beverage conduit 150, towards the upstream connector 130. The exterior liquid trap 160 is depicted, which prevents the flow of liquid 200 from reaching the upstream connector 130, in particular by deflecting the flow 200 over a protrusion 166 of the exterior liquid trap 160. The protrusion 166 can for example be formed by a length of tape as the exterior liquid trap 160.

It will be understood that beverage may flow through the beverage conduit 150 in a direction generally upward and/or generally against the direction of gravity, for example due to gas dissolved in the beverage from causing the beverage to foam out of the beverage outlet 142.

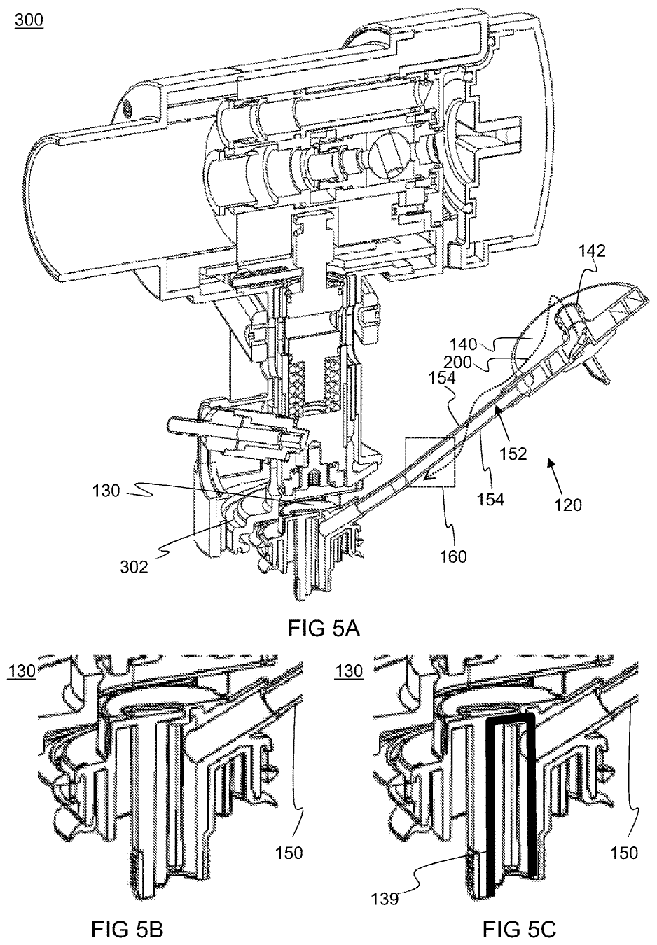

FIG. 5A shows a section view of a coupler device 300 of a beverage dispensing assembly, which coupler device can be used for coupling the dispensing line part 102 to a beverage container. An embodiment of a dispensing line part 102 is shown partially connected to the coupler device 300. In particular, the upstream connector 130 is connected to the coupler device 300, and the downstream connector 140 is shown disconnected from the coupler device 300. The coupler device 300 has a connector 302 for connecting the coupler device 300 to a beverage container, such as a keg, in particular to a neck portion of said beverage container.

In case the downstream connector 140 is disconnected from the coupler device 300, in particular after having previously been connected to the coupler device 300, a flow of beverage 200 may flow out of the downstream connector 140, in particular out of the beverage outlet 142 of the downstream connector 140. As schematically depicted in FIG. 5A, this flow of beverage 200 may flow over the downstream connector 140, and over the exterior surface 154 of the beverage conduit 150, generally in the direction of the upstream connector 130. An exterior liquid trap 160 is in FIG. 5A schematically shown preventing the flow of fluid 200 from reaching the upstream connector 130.

For any of the exterior liquid traps 160 in the present disclosure, the exterior liquid trap may be arranged for preventing a flow of liquid 200 flowing over an exterior surface 154 of the beverage conduit 150 from reaching a beverage contact surface of the upstream connector 130. Generally, the beverage contact surface may be defined as any part of the upstream connector 130 which in normal use contacts beverage, for example beverage from a beverage container to which the upstream connector is connected and/or from which the upstream connector receives beverage to be further transported via the passage of the beverage conduit to the downstream conduit, and subsequently to a beverage dispenser.

FIG. 5B shows a detailed view of part of FIG. 5A, focused on the upstream connector 130. FIG. 5C shows the same view as FIG. 5B, but with at least part of the beverage contact surface 139 accentuated. In general, it will be understood that is an aim of the exterior liquid trap 160 to prevent beverage flowing over the exterior of the beverage conduit 150 from reaching said beverage contact surface 139, in particular when the upstream connector 130 is not connected to a beverage container and the beverage contact surface 139 may be exposed—i.e. not protected from outside contaminants by the beverage container to which it can be connected.

Although in the figures the exterior liquid trap is shown directly connected to the beverage conduit, it will be appreciated that the exterior liquid trap may in alternative embodiments be connected to another part of the dispensing line part. For example, the exterior liquid trap may be connected to the upstream connector or the downstream connector. Generally, for any embodiment of the dispensing line part, the dispensing line part may comprise a plurality of exterior liquid traps according to any of the exterior liquid traps as disclosed herein. When the exterior liquid trap is not connected directly to the beverage conduit, in use, the exterior liquid trap may contact the exterior surface of the beverage conduit or at least be positioned in close proximity of the exterior surface of the beverage conduit.

It will be understood that different options disclosed in conjunction with a particular embodiment and/or figure may also be applied to other embodiments. This in particular but not exclusively applies for optional features disclosed in conjunction with the dispensing line part, exterior liquid trap, and upstream connector.

In particular, for any exterior liquid trap 160 depicted in conjunction with any of the FIGS. 1A-5C, the exterior liquid trap may comprise a hydrophobic exterior surface. Additionally or alternatively, the exterior liquid trap may be at least partially essentially nonporous for liquid, in particular for alcohol-free beer. Further additionally or alternatively, the exterior liquid trap may be at least partially essentially impermeable for liquid, in particular for alcohol-free beer.

1. A dispensing line part for use in a beverage dispensing assembly, the dispensing line part comprising:
a beverage conduit with a passage for transporting a non-alcoholic beverage through said conduit;
an upstream connector arranged for connecting the beverage conduit to a beverage container holding a non-alcoholic beverage, wherein the upstream connector has a beverage contact surface which in use contacts beverage; and
a downstream connector, arranged for connecting the beverage conduit to a beverage dispensing system;
wherein the beverage conduit extends between the upstream connector and the downstream connector, and
wherein the dispensing line part further comprises an exterior liquid trap, arranged for preventing a flow of liquid flowing over an exterior surface of the beverage conduit from reaching the beverage contact surface of the upstream connector.

2. The dispensing line part according to claim 1, wherein the exterior liquid trap is connected to or connectable to the exterior surface of the beverage conduit.

3. The dispensing line part according to claim wherein the exterior liquid trap is glued to or adheres to the exterior surface of the beverage conduit.

4. The dispensing line part according to claim 1, wherein the exterior liquid trap is or comprises a length of tape at least partially wrapped around the exterior surface of the beverage conduit, and wherein part of the length of tape extends away from the exterior surface of the beverage conduit.

5. The dispensing line part according to claim 4, wherein the length of tape is at least partially folded over the exterior surface of the beverage conduit, and wherein the tape is connected to itself.

6. The dispensing line part according to claim 1, wherein the exterior liquid trap is clamped onto the exterior surface of the beverage conduit.

7. The dispensing line part according to claim 1, wherein the exterior liquid trap is arranged to trap at least part of the flow of liquid flowing over the exterior surface of the beverage conduit from the downstream connector to the upstream connector.

8. The dispensing line part according to claim 7, wherein the exterior liquid trap comprises a liquid-absorbing material.

9. The dispensing line part according to claim 1, wherein the exterior liquid trap comprises a hydrophobic exterior surface.

10. The dispensing line part according to claim 1, wherein the exterior liquid trap has one or more visible markings on an outer surface of the exterior liquid trap.

11. A beverage dispensing assembly, comprising:
a beverage container with a container body defining a beverage chamber for containing a beverage, the container body comprising a beverage outlet;
a beverage dispenser, for dispensing the beverage at a dispensing outlet of the dispenser; and
a dispensing line part according to claim 1, wherein the dispensing line part is connected between the beverage container and the beverage dispenser.

12. The beverage dispensing assembly according to claim 11, wherein in use the upstream connector of the dispensing line part is positioned lower than the downstream connector of the dispensing line part.

13. The beverage dispensing assembly according to claim 12, wherein the exterior liquid trap of the dispensing line part is positioned at a height between the upstream connector and the downstream connector.

14. The beverage dispensing assembly according to claim 11, wherein the beverage chamber contains a non-alcoholic beverage, beer.

15. The beverage dispensing assembly according to claim 11, further comprising a coupler device for coupling the dispensing line part to the beverage container.

16. The beverage dispensing assembly according to claim 14, wherein the non-alcoholic beverage is a carbonated non-alcoholic beverage.

17. The beverage dispensing assembly according to claim 14, wherein the non-alcoholic beverage is an alcohol-free beer.

18. The dispensing line part according to claim 5, wherein outer ends of the length of tape are connected with or near each other.
